(19) United States
(12) Patent Application Publication
(10) Pub. No.: US 2007/0083517 A1
(43) Pub. Date: Apr. 12, 2007

(54) Network system and a method for managing building inspections

(75) Inventors: Edward Saul Prince, Charlotte, NC (US); James Nicholas Bartl, Davidson, NC (US); Wendy B. Gigante, Huntersville, NC (US); Patrick Gerard Granson, Charlotte, NC (US); Lewis Gene Morton, Charlotte, NC (US)

Correspondence Address: HAMMER & HANF, PC, 3125 SPRINGBANK LANE, SUITE G, CHARLOTTE, NC, 28226, US

(73) Assignee: Mecklenburg County

(21) Appl. No.: 11/248,097

(22) Filed: Oct. 12, 2005

(51) Int. Cl. G06F 17/30

(52) U.S. Cl. 707/9

(57) ABSTRACT

The instant invention is a network system and a method for managing building inspections. The network system for managing building inspections, according to instant invention, includes a central site, a user site, a data manager site, and an administrator site. The central site includes a first database, a second database, and the means for communicating electronically with a remote computer. The first database receives information related to building inspection requirements from at least one data manager, and it includes means for controlling the unidirectional transmission of the building inspection requirements into the first database. The second database is operatively connected to the first database, and it controls the access of the data managers to the first database. The user site includes at least one user access point, which provides access to users to only view, read, print, search or save the information stored in the first database. The data manager site includes at least one data manager access point, which provides access to data managers to only view, read, print, search, or save the information stored in the first database and to add new information in the first database. The administrator site includes at least one administrator access point, which provides access to view, read, print, search, save, or modify the information stored in second database or to add new information into second database. Furthermore, the method for managing building inspections, according to instant invention, includes providing a network system for managing building inspections, as described above, and managing building inspections via said network system.

### FIELD OF INVENTION

The instant application relates to a network system and a method for managing building inspections.

### BACKGROUND OF THE INVENTION

The building inspection process is critical to the building construction projects and is preformed to verify that each construction project is completed in accordance with state and local building codes and ordinances.

In general, a construction permit is obtained and posted on the job site prior to any inspection being performed. A wide range of building inspections are performed sequentially during various stages of a building construction project. In order for a building construction project to advance into a next stage, the inspection required therefor must be passed. At the completion of each inspection, whether passed or failed, a written report is produced and filed. If at any stage of the building construction project, an inspection has failed, then the problem must be rectified before a re-inspection is performed. However, if at any stage of the building construction project, an inspection has failed, but it was undetected, for example due to filing errors, then it may become highly costly to rectify the problem when the construction project has moved forward to the next stage.

U.S. Pat. No. 4,370,707 discloses a computer system for preparing a complete set of architectural specifications for constructing a building, including, if desired, a set of instructions that will be used by personnel during preparation of construction drawings and during construction.

U.S. Pat. No. 4,964,060 discloses a plan checking data processing system. This plan checking data processing system has an input for providing a development plan to be checked to the system in a form intelligible to the system. A memory contains standards against which the development plan is to be checked, also in a form intelligible to the system. A program is used by processor for evaluating the development plan according to the standards, and an output receives the results of the evaluation.

U.S. Pat. No. 5,761,674 discloses an integrated construction project information management system. This integrated construction project information management system has a project model constructed by combining a product model that defines a product with the use of physical and functional elements. The integrated construction project information management system also has a process model having elements, which are described as hierarchical objects in the form of views arranged along a flow of productive activities. The system further has interfaces between the project model on the one hand, and other systems and a database on the other hand, and a user interface.

U.S. Pat. No. 6,014,503 discloses a building renovation supporting apparatus capable of drafting and presenting efficient renovation plans. The proposing means of the building renovation supporting apparatus creates the renovation blueprints composed of third dimensional path diagrams of particular viewpoint, line of sight direction and the view angle corresponding to each types of condition of the symbol diagram to be inputted from an inputting means.

U.S. Pat. No. 6,446,053 discloses a computerized system, which includes a central site with various databases and a user site connected for electronic communication system such as the internet. The user site includes a computer having stored in memory an application that enables a user to develop a construction proposal including a detailed graphical model and a detailed cost estimate model, have the proposal submitted electronically over a network communication system to a construction professional for a bid, and receive a response on the proposal from the construction professional over the network communications system.

U.S. Pat. No. 6,842,760 discloses a method and apparatus for highly automated quality assurance of building construction projects. A tracking form is prepared for one or more tasks requiring completion at the construction site. Each task is assigned two components on its tracking form: a quality color indicator form, and a completion indicator. The completion status may be a discrete binary value, or it may instead be a continuous value. The completion indicators relating to the tasks are logged so that the completion status of the project may be monitored, and the information recorded on the quality control indicator forms may be sampled and checked to verify that construction quality standards are being met.

United States Patent Application Publication No. 2004/0215633 discloses a network based construction project management system. The system includes network accessible databases of project information including drawings and specifications. The system allows for varying amount of access for various users including general contractors, subcontractors, architects, and project owners. The system allows for the effective creation, management, and long-term storage of project submittals.

Despite the research efforts in developing network systems for managing construction projects, there is a still a need for a network system for managing building inspections, which provides a high level of quality assurance for building construction projects, and further provides a paperless inspection management system. Additionally, there is still a need for a method for managing building inspections, which provides a high level of quality assurance for building construction projects, and further provides a paperless inspection management system.

### SUMMARY OF THE INVENTION

The instant invention is a network system and a method for managing building inspections. The network system for managing building inspections, according to instant invention, includes a central site, a user site, a data manager site, and an administrator site. The central site includes a first database, a second database, and the means for communicating electronically with a remote computer. The first database receives information related to building inspection requirements from at least one data manager, and it includes means for controlling the unidirectional transmission of the building inspection requirements into the first database. The second database is operatively connected to the first database, and it controls the access of the data managers to the first database. The user site includes at least one user access point, which provides access to users to only view, read, print, search or save the information stored in the first database. The data manager site includes at least one data manager access point, which provides access to data managers to only view, read, print, search, or save the information stored in the first database and to add new information in the first database. The administrator site includes at least one administrator access point, which provides access to view, read, print, search, save, or modify the information stored in second database or to add new information into second database. Furthermore, the method for managing building inspections, according to instant invention, includes providing a network system for managing building inspections, as described above, and managing building inspections via said network system.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic block diagram of a network system for managing building inspections according to instant invention;

FIG. 2 shows hierarchical structure of the special inspections types;

FIG. 3 is a flow chart schematically illustrating the plan review phase of special inspections timeline;

FIG. 4 is a flow chart schematically illustrating the pre-construction phase of special inspections timeline;

FIG. 5 is a flow chart schematically illustrating the construction phase of special inspections timeline; and

FIG. 6 is a flow chart schematically illustrating the close out phase of special inspections timeline.

### DETAILED DESCRIPTION OF THE INVENTION

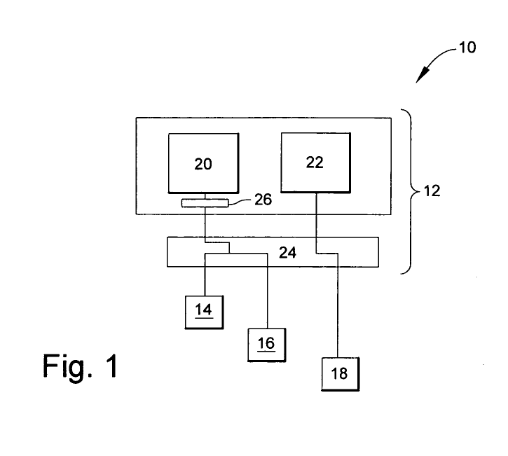

Referring to the drawings wherein like numerals indicate like elements, there is shown, in FIG. 1, a schematic block diagram of a preferred embodiment of a network system 10 for managing building inspections according to instant invention. Network system 10 includes a central site 12, a user site 14, a data manager site 16, and an administrator site 18. The central site 12 includes a first database 20, a second database 22, and the means 24 for communicating electronically with a remote computer.

The instant application, for convenience, is further discussed with regard to a network system and a method for managing special inspections; however, the instant invention is not so limited, and it may include a network system and a method for managing any building inspections.

Special inspections, as used herein, refers to, including but not limited to, code compliance issues that directly effect life safety in order to provide minimum level of quality control for selected structural integrity and safety issues of a building project.

The terms “information” and “data,” as used herein, are used interchangeably to mean the same.

Referring to FIG. 1, first database 20 may be any database; for example, database 20 may be a collection of first data (not shown) stored on a first computer data storage medium. The collection of first data stored on a first computer data storage medium may include any information including but not limited to, information related to building inspection requirements, e.g. special inspections requirements, information related to contractors, information related to contracting firms, or information related to building projects.

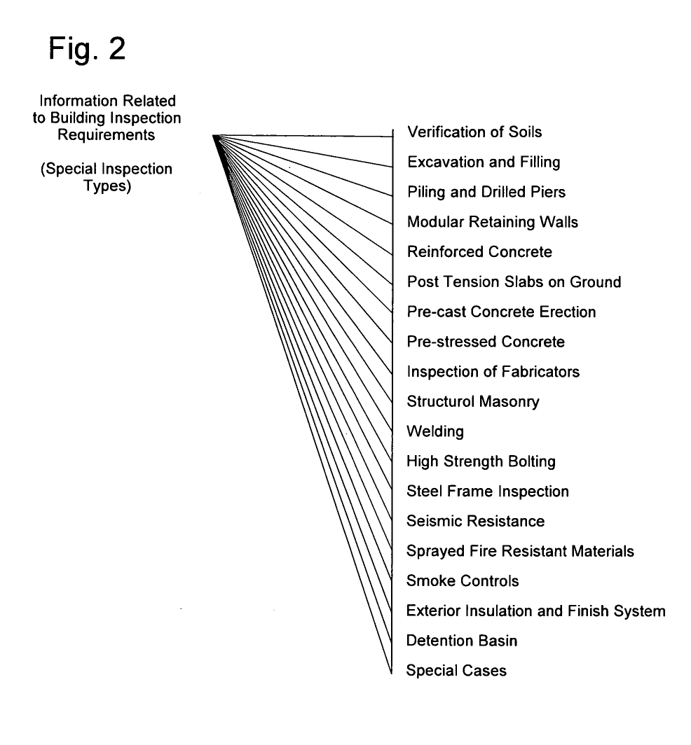

Referring to FIG. 2, special inspections may include any type special inspections. Special inspections types may be selected from the group consisting of verification of soils, excavation and filing, piling and drilled piers, modular retaining walls, reinforced concrete, post tension slabs-on-ground, pre-cast concrete erection, pre-stressed concrete, inspection of fabricators, structural masonry, welding, bolting (e.g. high-strength bolting), steel frame inspection, seismic resistance, fire resistant materials, smoke controls, exterior insulation and finish system, detention basin, special cases, combinations thereof, and the like.

Information related to contractors may include any information; for example, name, contact information, employment, qualifications, licenses, and eligibility.

Information related to contracting firms may include any information; for example, name, contact information, qualifications, licenses, and eligibility.

Information related to building projects may include any information; for example, name and contact information of the owner of the building project, address of the building project, the name and contact information of the contracting firm in charge of the building project, the name and contact information of the contractor in charge of the building project, the name and contact information of the data manager in charge of the building project, the qualification of the contractor or the contracting firm, contractor's licenses, contracting firm's licenses, building project permit number, building project permit number issuance date, building project permit restrictions, building project identification number, combinations thereof, or the like.

First storage data media are generally known to a person skill in the art. In general, first storage data medium may be any computer storage data medium including, but not limited to, an internal hard disk, an external hard disk, a memory stick, a compact disk, a diskette, and the like. Preferably, the first storage data medium is an internal hard disk or an external hard disk.

First database 20 may store data, e.g. the collection of first data, in any format; for example first database 20 may store data, e.g. the collection of first data, in a Portable Document File (“PDF”) format, or a Hypertext Markup Language (“HTML”) document format. Preferably, first database 20 stores data, e.g. the collection of first data, in a PDF format. The data stored in first database 20, e.g. the collection of first data, may be organized in any manner; for example, the information stored in the first database 20, e.g. the collection of first data, may be organized into a hierarchical system. The first database 20 may further be adapted to facilitate the search for a specific piece of data, i.e. a PDF, from the collection of first data stored therein. The data, e.g. the collection of first data, stored in first database 20 may further be electronically tagged to facilitate the search therefor. The first database 20 may further include a library of forms (not shown). The data, e.g. the collection of first data, may be stored in first database 20 permanently. Additionally, the data, e.g. the collection of first data stored in first database 20, may be backed up incrementally for archival storage.

First database 20 may further include the means 26 for controlling a unidirectional transmission of data or information, e.g. building requirement information, into the first database 20. The means 26 for controlling a unidirectional transmission of data or information may be any means; for example, means 26 may be an electronic gate for controlling a unidirectional transmission of data or information into the first database 20. Means 26 may allow a data manager to only view, read, print, search, or save any portion of the data or information stored in first database 20, or in the alternative, to add or input new information or data into the first database 20; however, means 26 prevents the data managers or any other end user from modifying or deleting any existing data or information stored in the first database 20. Means 26 may further allow an end user, e.g. any member of the public, to only view, read, print, search or save any portion of the information or data stored in first database 20; however, means 26 prevents any end user from adding or inputting data into the first database 20 or prevents any end user from modifying or deleting any existing data or information in the first database 20.

Referring to FIG. 1, second database 22 may be any database; for example, second database 22 may be a collection of second data (not shown) stored on a second computer data storage medium. The collection of second data stored on the second computer data storage medium may include any data including, but not limited to, information related to data managers. A data manager may be any individual, for example, a data manager may be an inspector, e.g. an authorized special inspector (“ASI”) or a designated special inspector (“DSI”). The information related to data managers may include any information; for example, name and contact information of the data managers, qualification of the data managers, certification of the data managers, security access codes, combinations thereof, or the like.

Second database 22 may store data, e.g. the collection of second data, in any format; for example second database 22 may store data, e.g. the collection of second data, in a Portable Document File (“PDF”) format, or a Hypertext Markup Language (“HTML”) document format. Preferably, second database 22 stores data, e.g. the collection of second data, in a HTML document format. The data stored in second database 22, e.g. the collection of second data, may be organized in any manner; for example, the data stored in the second database 22, e.g. the collection of second data, may be organized into an alphabetical system. The second database 22 may further be adapted to facilitate the search for a specific piece of information or data, i.e. information related to a data manager, from the collection of second data stored therein. The information or data, e.g. the collection of second data, stored in second database 22 may further be adapted to facilitate the search therefor.

Referring to FIG. 1, second database 22 may be operatively connected to first database 20. Second database 22 may be adapted to control the access of the data managers to the first database 20. For example, second database 22 may be adapted to restrict the access of data managers to first database 20 to only view or read any portion of the information stored in first database 20, to print any portion of the information stored in first database 20, to search any portion of the information stored in first database 20, to save any portion of the information stored in first database 20, or in the alternative, to add or input any new data or information into the first database 20, and to prevent data managers from modifying or deleting any existing information or portion thereof stored in the first database 20. Second database 22 may further be adapted to restrict the access of any end user to the first database 20 to only view or read any portion of the information stored in first database 20, to print any portion of the information stored in first database 20, to search any portion of the information stored in first database 20, or to save any portion of the information stored in first database 20, and to prevent any end user from adding or inputting data or information into the first database 20, or to prevent any end user from modifying or deleting any information or data stored in the first database 20. The data managers may be provided with a data manager security access code to access the information stored in first database 20. The data manager access code may, for example, be an alphanumerical code.

The central site 12 may further include a central processing unit (not shown), an input device, e.g. a keyboard interface or a mouse (not shown), or an output device, e.g. a monitor or a printer.

The user site 12 may be any computer. For example, user site 12 may be a computer including a memory, a central processing, an input device, e.g. a keyboard interface or a mouse, a storage device, as described hereinabove, or an output device, e.g. a monitor or a printer. The user site 12 may include at least one user access point providing a user to only read or view any portion of the information stored in said first database 20, to print any portion of the data or information stored in said first database 20, to search any portion of the information stored in first database 20, or to save any portion of the data or information stored in said first database 20, and to prevent any end user from adding or inputting new data or information into the first database 20, or to prevent any end user from modifying or deleting any information or data stored in the first database 20. The user site 12 may be a separate computer operatively connected to the central site 12, or in the alternative, it may be an integrated component of the central site 12. The user site 12 may be connected to central site 12 via internet or intranet. The user site 12 may have access to internet or intranet via modem, cable, Digital Subscriber Line (“DSL”), or wireless. Each end user may be provided with an end user security access code to access the information stored in first database 20. The end user access code may, for example, be an alphanumerical code.

Data manager site 16 may be any computer. For example, the data manager site 16 may be a computer including a memory, a central processing, an input device, e.g. a keyboard interface, a mouse, or a scanner, a storage device, as described hereinabove, or an output device, e.g. a monitor or a printer. The data manager site 16 may include at least one data manager access point (not shown) providing data managers access to first database 20 to only read or view any portion of the information or data stored in the first database 20, to print any portion of the information or data stored in the first database 20, to search any portion of the information stored in first database 20, to save any portion of the information or data stored in the first database 20, or to input or add new information or data into the first database 20, and to prevent data managers from modifying or deleting any existing information or portion thereof stored in the first database 20. The data manager site 16 may be a separate computer operatively connected to the central site 12, or in the alternative, it may be an integrated component of the central site 12. The data manager site 16 may be connected to central site 12 via internet or intranet. The data manager site 16 may have access to internet or intranet via modem, cable, DSL, or wireless. Each data manager may be provided with a data manager security access code to access the information stored in first database 20. The data manager access code may, for example, be an alphanumerical code.

Administrator site 18 may be any computer. For example, the administrator site 18 may be a computer including a memory, a central processing, an input device, e.g. a keyboard interface, a mouse, or a scanner, or an output device, e.g. a monitor or a printer. The administrator site 18 may include at least one administrator access point (not shown) providing access to an administrator to the second database 22 in order to read or view the information stored in second database 22, to delete or modify information or data stored in the second database 22, or in the alternative, to input or add new data or information into the second database 22. The administrator site 18 may be any separate computer operatively connected to the central site 12, or in the alternative, it may be an integrated component of the central site 12. The administrator site 18 may be connected to central site 12 via internet or intranet. The administrator site 18 may have access to internet or intranet via modem, cable, DSL, or wireless. Each administrator may be provided with an administrator security access code to access the information stored in second database 22. The administrator access code may, for example, be an alphanumerical code.

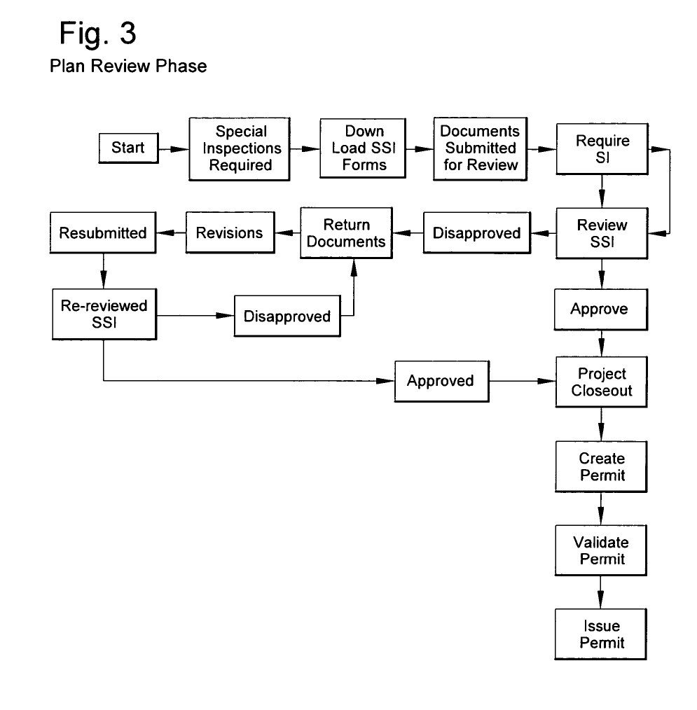

Generally, referring to FIGS. 3-6, a special inspections timeline includes, but is not limited to, a plan review phase, a pre-construction phase, a construction phase, and a close out phase.

Referring to FIG. 3, the plan review phase is commenced with the determining whether special inspections are required or not. If it is determined that special inspections are not required, then the project may proceed with no special inspections. In the alternative, if it is determined that special inspections are required, then special inspections start, and a Design Professional in Responsible Charge (“DPIRC”) accesses the first database 20 to view and print statement of special inspections (“SSI”). The DPIRC completes the statement of special inspections, and includes and reproduces it on the project drawings. Subsequently, the contract documents including the statement of special inspections are submitted for commercial plan review to a plan examiner. The plan examiner, who receives the contract documents including the statement of special inspections, designates certain projects as special inspections projects, e.g. by checking a box. The plan examiner further reviews the contract documents including the statement of special inspections for the scope of the work and compliance. If the contract documents including the statement of special inspections are disapproved by the plan examiner, the contract documents including the statement of special inspections are returned to DPIRC for revisions. DPIRC may make the proper steps to revise the statement of special inspections or the contract documents, and resubmit them to the plan examiner for further review to be approved or disapproved. In the alternative, if contract documents including the statement of special inspections are approved, the project will move forward to the project close out, and a permit is created. The permit is validated, and it is issued to a general contractor.

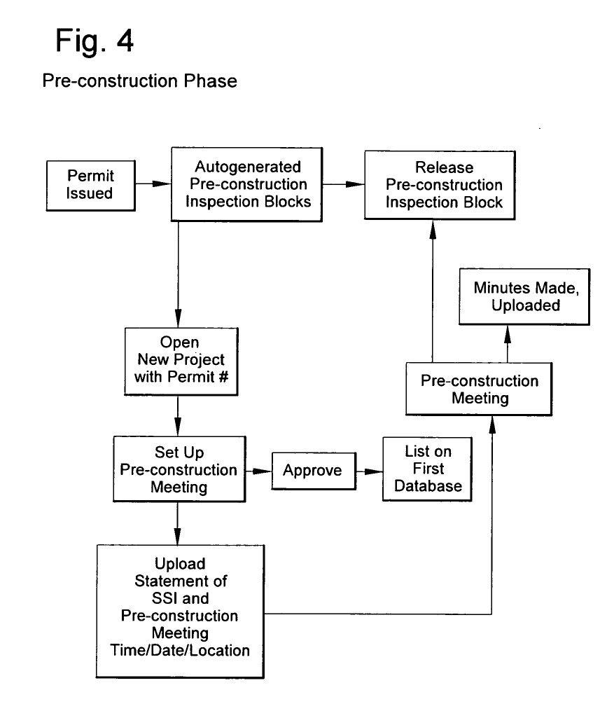

Referring to FIG. 4, once the permit is issued to a general contractor, the special inspections timeline will move forward to the pre-construction phase. In pre-construction phase, pre-construction inspection blocks are automatically generated on new projects, and no inspection requests are accepted until a pre-construction meeting is completed and the building inspector releases pre-construction inspection blocks. Pre-construction meeting, as used herein, may include DPIRC, the Contractor, ASI, and/or DSI. Concurrently with the automatic pre-construction inspection blocks on a new building project, DSI may also access information on the new building project, for example by a permit number. Next, DSI or a general contractor may contact the building inspector to schedule a pre-construction meeting including date, time, and location of the meeting. DSI, subsequently, may upload the statement of special inspections with pre-construction meeting schedule including date, time, and location into first database 20. The pre-construction meeting is realized, and minutes of the meeting are reproduced by the DPIRC, and transmitted into the first database 20 by the DSI. Subsequently, the building inspector may release the pre-construction inspection blocks.

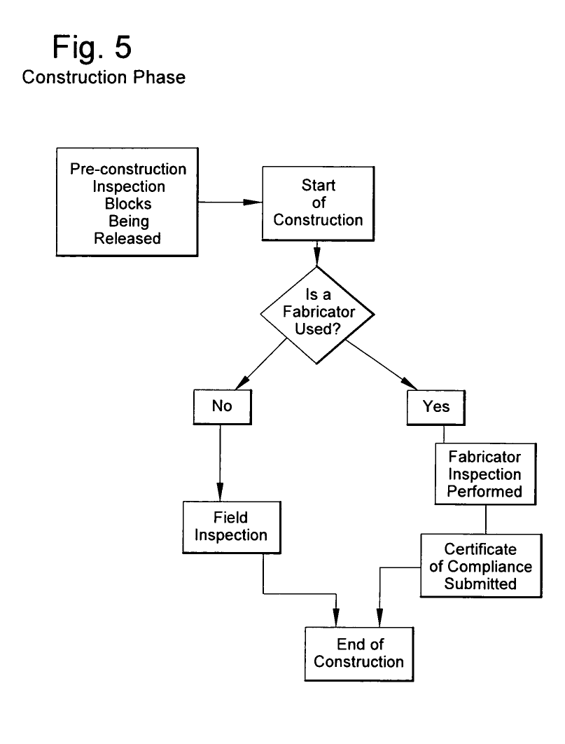

Referring to FIG. 5, once the building inspector has released the pre-construction inspection blocks, then the construction starts. Concurrently with the start of the construction, there would be a determination of whether a fabricator is used or not. A fabricator, as used herein, refers to a manufacturer of any structural load-bearing member or assembly that is manufactured or assembled at any location other than the construction site (off-site). If a fabricator is used, then the special inspections of fabricator inspection is performed by a special inspections firm. At the completion of fabrication, the fabricator may be required to submit a certificate of compliance to the special inspections firm, and the construction phase moves forward to the end of construction. Proper history of such special inspections are reproduced, and transmitted and uploaded into the first database 20. The information transmitted and stored into the first database 20 may be searched, viewed, printed, saved and/or added thereto by an authorized person; however, the information and data transmitted and stored in first database 20 may not be modified, or deleted by anyone. The information transmitted and stored into the first database 20 may be searched, viewed, saved and/or printed by any member of the public. In the alternative, if no fabricator is used, then field special inspections begin, and the construction phase moves forward to the end of construction. During the field special inspections, proper history of such inspections are reproduced, and transmitted and uploaded into the first database 20. The information transmitted and stored into the first database 20 may be searched, viewed, printed, saved and/or added thereto by an authorized person, e.g. DSI; however, the information and data transmitted and stored in first database 20 may not be modified, or deleted by anyone. The information transmitted and stored into the first database 20 may be searched, viewed, saved and/or printed by any member of the public.

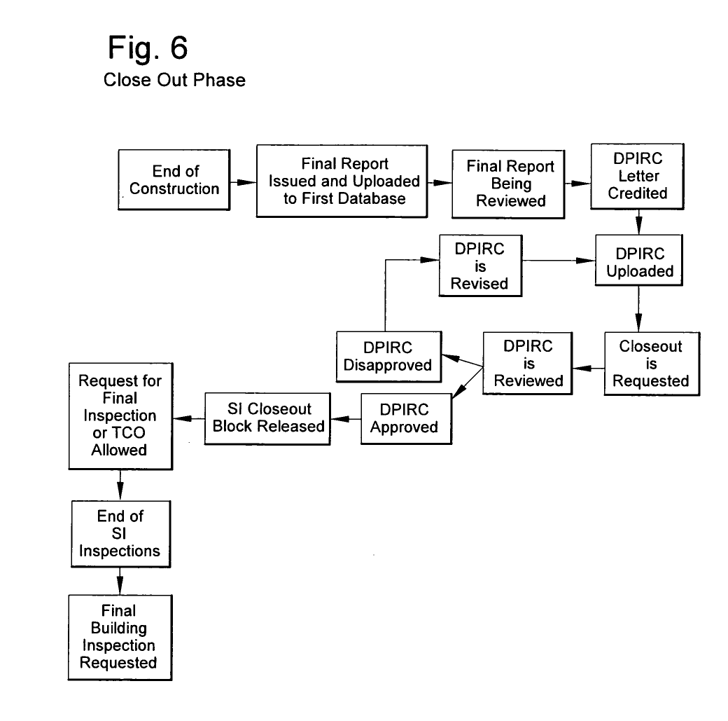

Referring to FIG. 6, once at the end of construction, the special inspections timeline will proceed to the close out. DSI may issue a final report of the special inspections, and transmit it into the first database 20, and store it therein. Additional final reports may be required for building projects with multiple designated special inspections, and each of such reports may be transmitted into the first database 20, and stored therein. Next, a DPIRC may review the final reports, and then the DPIRC may generate a final letter, e.g. a design professional in responsible charge letter (“DPIRC letter”). The DPIRC letter may be transmitted into the first database 20 by an authorized person, e.g. DSI. Subsequently, a general contractor may request for special inspection close out. Accordingly, a building inspector may review the DPIRC letter. If the DPIRC letter is approved, the special inspections close out block is removed, and request for a temporary certificate of occupancy (“TCO”) or final inspection is allowed. Thus, bringing the special inspections timeline to the end of special inspections; therefore, the general contractor may request for the final building inspection. In the alternative, if the DPIRC letter is disapproved by the building inspector, the DPIRC letter is returned to DPIRC for revision. The DPIRC may revise the DPIRC letter, and transmit it into the first database 20. The building inspector reviews the DPIRC letter.

The computer implemented method for managing building inspections, according to instant invention, includes providing a network system 10 for managing building inspections, as described hereinabove, and managing building inspections via said network system 10.

The present invention may be embodied in other forms without departing from the spirit and the essential attributes thereof, and, accordingly, reference should be made to the appended claims, rather than to the foregoing specification, as indicated the scope of the invention.

We claim:

1. A network system for managing building inspections comprising:
a central site comprising;
a first database for receiving information related to building inspection requirements from at least one data manager, said first database including means for controlling a unidirectional transmission of said building inspection requirements into said first database;
a second database being operatively connected to said first database for controlling the access of said data manager to said first database; and
means for communicating electronically with a remote computer;
a user site comprising at least one user access point providing access to only view, read, print, search, or save the information stored in said first database;
a data manager site comprising at least one data manager access point providing access to only view, read, print, search, or save the information stored in said first database or to add new information in said first database; and
an administrator site comprising at least one administrator access point providing access to view, read, print, search, modify or save information stored in said second database, or to add new information in said second database.

2. The network system for managing building inspections according to claim 1, wherein said means for controlling a unidirectional transmission of said building inspection requirements into said first database being an electronic gate.

3. The network system for managing building inspections according to claim 1, wherein said information related to building inspection requirements being an inspection type selected from the group consisting of verification of soils, excavation and filling, piling and drilled piers, modular retaining walls, reinforced concrete, post tension slabs-on-ground, pre-cast concrete erection, pre-stressed concrete, inspection of fabricators, structural masonry, welding, combinations thereof, and the like.

4. The network system for managing building inspections according to claim 1, wherein said first database stores said information related to building inspection requirements in a hierarchical filing system.

5. The network system for managing building inspections according to claim 1, wherein said data manager being provided with a data manager security access code to access said first database.

6. The network system for managing building inspections according to claim 1, wherein said administrator being provided a an administrator security access code to access said first database and said second database.

7. The network system for managing building inspections according to claim 1, wherein said first database further including a library of forms.

8. The network system for managing building inspections according to claim 1, wherein said information related to building inspection requirements being stored permanently.

9. The network system for managing building inspections according to claim 8, wherein said permanently stored information related to inspection requirements being backed up incrementally for archival storage.

10. A computer implemented method for managing building inspections comprising the steps of:
providing a network system for managing building inspections comprising:
a central site comprising;
a first database for receiving information related to building inspection requirements from at least one data manager, said first database including means for controlling a unidirectional transmission of said building inspection requirements into said first database;
a second database being operatively connected to said first database for controlling the access of said data manager to said first database; and
means for communicating electronically with a remote computer;
a user site comprising at least one user access point providing access to only view, read, print, search, or save the information stored in said first database;
a data manager site comprising at least one data manager access point providing access to only view, read, print, search, or save the information stored in said first database or to add new information in said first database; and
an administrator site comprising at least one administrator access point providing access to view, read, print, search, modify or save information stored in said second database, or to add new information in said second database; and
managing building inspections via said network system.

11. The computer implemented method for managing building inspections according to claim 10, wherein said means for controlling a unidirectional transmission of said building inspection requirements into said first database being an electronic gate.

12. The computer implemented method for managing building inspections according to claim 10, wherein said information related to building inspection requirements being an inspection type selected from the group consisting of verification of soils, excavation and filling, piling and drilled piers, modular retaining walls, reinforced concrete, post tension slabs-on-ground, pre-cast concrete erection, pre-stressed concrete, inspection of fabricators, structural masonry, welding, combinations thereof, and the like.

13. The computer implemented method for managing building inspections according to claim 10, wherein said first database stores said information related to building inspection requirements in a hierarchical filing system.

14. The computer implemented method for managing building inspections according to claim 10, wherein said data manager being provided with a data manager security access code to access said first database.

15. The computer implemented method for managing building inspections according to claim 10, wherein said administrator being provided an administrator security access code to access said first database and said second database.

16. The computer implemented method for managing building inspections according to claim 10, wherein said first database further including a library of forms.

17. The computer implemented method for managing building inspections according to claim 10, wherein said information related to building inspection requirements being stored permanently.

18. The computer implemented method for managing building inspections according to claim 17, wherein said permanently stored information related to inspection requirements being backed up incrementally for archival storage.
